(19) United States
(12) Patent Application Publication
(10) Pub. No.: US 2005/0029327 A1
(43) Pub. Date: Feb. 10, 2005

(54) Welding process and device

(76) Inventor: Frank Becherer, Haslach (DE)

Correspondence Address: NATH & ASSOCIATES, 1030 15th STREET, NW, 6TH FLOOR, WASHINGTON, DC, 20005, US

(21) Appl. No.: 10/837,906

(22) Filed: May 4, 2004

(30) Foreign Application Priority Data
Aug. 9, 2003 (DE) 103 36 693.8

(51) Int. Cl. B23K 37/04

(52) U.S. Cl. 228/49.1

(57) ABSTRACT

A process, a welding device, and an auxiliary welding material for welding a welding seam between two structural components, particularly in the production of a filling level gauge The invention relates to a process, a welding device, and an auxiliary welding material for welding a welding seam between structural components in the production of a filling level gauge. In a known manner the first and second structural parts are placed together, and an auxiliary welding material is prepared and introduced, whereupon the first such structural component and the second structural component are welded together using the auxiliary welding material upon the introduction of heat. To permit a more uniform welding seam the auxiliary welding material is inserted before welding as a shaped auxiliary welding material into the area of the welding seam between the first and the second structural components, and the shape of the auxiliary welding seam is at least partially adjusted to the shape of the welding seam.

The invention relates to a process with the features of patent claim 1 for welding a seam between two structural parts; it also relates to a welding device and to an auxiliary welding material for implementing the process.

It is generally known to place two structural parts together and to weld them together such that a welding seam is formed. In the process, an auxiliary welding material may be added in the form of a wire and may be fed into the welding bath. With the introduction of heat the first and second structural parts are welded together along with the auxiliary welding substance.

In producing a filling level gauge an existing problem consists of welding a pipe to a process connecting piece that exhibits an opening. Usually the process connecting piece and the pipe are welded together (or two pipes are welded together); here the welded parts consist of high-quality steel, e.g., V4A steel.

Of special difficulty is the welding of circular seams on rotationally symmetrical bodies, such as the pipes mentioned above, while using an auxiliary welding material. Particularly in the case of laser welding it is necessary to use a high degree of precision in adding an auxiliary welding material to a welding joint between the two structural components being welded.

Since this is very difficult, laser weldings are usually performed as a round seam without the use of auxiliary material. If it is nonetheless necessary to use an auxiliary welding material—e.g., due to the combination of materials being welded—the latter must be very precisely added to the welding bath in wire form. The precise positioning is necessary here because the laser beam has a very small area of effect. If the wire changes its position in only a small area the quality of the welding seam will often no longer suffice or the process may be disrupted by an equipment standstill.

The goal of the invention consists in improving a process, a welding device, and an auxiliary welding material, for welding a seam between two structural components with a view to the precision of the welding event and the resulting seam.

This goal is achieved in a process for welding a seam between two structural components exhibiting the features of patent claim 1, in a welding device with the features of patent claim 4, and in an auxiliary welding material with the features of patent claim 5.

The point of departure for the invention is a process for welding a seam between two structural components, particularly in the production of a filling level gauge, where in the process an initial structural component and a second structural component are put together, an auxiliary welding material is prepared or introduced, and the first structural component is welded to the second structural component using the auxiliary welding material upon the introduction of heat. To increase precision it is advantageous if the auxiliary welding material is shaped before welding and is placed in the vicinity of the welding seam located between the first and the second structural components, and if the shape of the auxiliary welding material is at least partially adapted to the shape of the welding seam.

A welding device for welding a seam between two structural components while using a process of this kind conventionally exhibits a holding device for holding in position the two structural components and the auxiliary welding substance employed. It is advantageous if the holding device is designed in such a way that the two structural components are so held that the shaped auxiliary welding material remains in the area between the structural components during the act of welding.

An auxiliary welding material for this kind of process, or to be employed in this kind of welding device, will advantageously be shaped in such a way as to accommodate the welding seam in whose area the auxiliary welding material is used.

It is therefore desirable to employ a preformed auxiliary welding material. Here the shape of the auxiliary welding material is adjusted to the area of the welding seam at and/or between the two structural components being welded together.

Advantageous embodiments are the subject material of dependent claims.

Particularly for a structural component with a circular end piece which is to be welded to the other component, it is advantageous if the auxiliary welding material is formed and prepared so as to have a circular shape. The auxiliary welding material can then be prepared in the area of the welding seam or the welding joint in order to permit an orientation that is optimal for the welding process. Lateral variations and movement, as is customary when a wire is introduced as an auxiliary material, are avoided. Naturally the auxiliary welding material can be prepared in other shapes if the structural components being welded together do not have a circular end piece.

In addition to the possibility of pushing this kind of shaped auxiliary welding material over a joint between the structural components being welded, there exists the possibility of inserting the pre-shaped auxiliary welding material between the two components being welded. This is particularly advantageous if the two structural components being welded consist of different materials and the auxiliary welding material must be inserted between the two components to permit the formation an adequate qualitative connection between them.

An exemplary embodiment is described in greater detail below on the basis of the drawing, which shows:

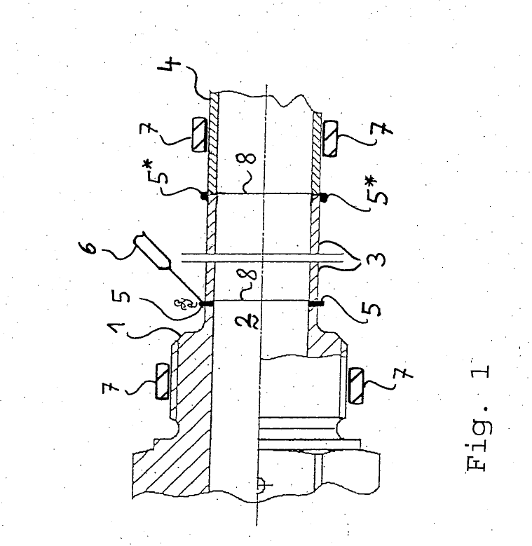

FIG. 1A cross-section through three structural components welded together and elements of a welding device

FIG. 1 shows a situation in which several structural components 1, 2, 4 must be welded together. The depicted exemplary embodiment deals with the process connecting piece 1 of a filling level meter exhibiting an opening 2. In the rim area of the opening 2, an extension pipe 3 is to be welded to the process connecting piece 1 as a counterpart. Also depicted is another structural component 4, for example, another piece of pipe, which is to be welded to the opposite end of the extension pipe 3.

When the three parts are welded together, the three parts, or two of the three, are fitted together, while the given auxiliary welding material 5, 5* is interposed in the area of the welding joint. The auxiliary welding material 5, 5* consists of a material which is particularly suited for connecting the adjacent structural components 1, 3 or 3, 4. The welding seam is then formed by welding the two adjacent structural components 1, 3; 3, 4 with the auxiliary welding material. Ideally a welding device 6 will be used for this purpose, one which directs a laser ray at the auxiliary welding material 5, 5*, or at the welding seam 8 that is forming.

In order to optimally position the auxiliary welding material 5, 5* between the structural components 1, 3; 3, 4 being welded together a shaped auxiliary welding material 5, 5* will be prepared and employed. In the case of tubular structural components 1, 3; 3, 4 the auxiliary welding material will expediently be given a circular shape. Preferred here is a flattened form comparable to a sealing ring, which in pipeline construction is placed between two facing pipe ends in order to seal them. In the present case, however, the shaped auxiliary welding material 5, 5* consists of an auxiliary material for forming a welding seam.

A welding device for supporting this kind of welding process will ideally exhibit a holding device 7 for clamping the structural components 1, 4 being welded together. After the shaped auxiliary welding materials 5, 5* have been positioned in the area of the welding joint the structural components 1, 3, 4 will be clamped in the holding device 7 in such a way that the individual structural components and the elements of the auxiliary welding material 1, 3-4 are optimally positioned relative to each other. Then using the welding device 6 as a component part of the welding device the welding seam, or in the present case the two welding seams, 8 are formed by welding the structural components and the auxiliary welding material. In the case of clamped tubular structural elements the welding device may be designed in such a way that the welding device 6 is automatically rotated around the parts being welded, or the clamped structural components being welded are rotated around a central axis of rotation. Depending on the materials being welded, the welding device will also be designed so as to implement the entire welding process in an appropriate atmosphere, ideally one without atmospheric oxygen.

In manufacturing a filling level gauge with a process connecting piece 1 as one structural component and with an attached extension pipe 3 as another structural component for attachment to yet a third part, particularly to another piece of piping 4, high-grade steel is the preferred material for the process connecting piece 1, the extension pipe 3, and the other piece of piping 4, particularly V4A steel with material number 1.4435. This material, which is mentioned only as an example, has a limited C content of maximum 0.03%, a chromium content of Cr 17-18%, a molybdenum content of Mo 2.5-3.0%, and a nickel content of Ni 12.5-14%. For classical quality the ferrite quantity is 0%. In welding this material the preferred auxiliary welding material 5, 5* is material no. 1.4430 or 1.4576. Material no. 1.4430 has a comparable composition, with primary components chromium 19%, nickel 12%, and molybdenum 3% and is characterized by an increased delta δ-ferrite content.

The insertion of the auxiliary welding material 5 between two structural components 1, 3 that are to be welded makes it possible to advantageously produce a particularly high-quality welding seam 8. The process is further improved in that the auxiliary welding material is already pre-shaped such that it can be optimally inserted into the welding joint between the two structural components 1, 3 being welded. In addition to this insertion of the auxiliary welding material 5 between the two structural components 1, 3, it is also generally advantageous to prepare a shaped auxiliary welding material 5* which, in the case of tubular parts being welded together, is shaped with an inner diameter that corresponds to the outer diameter of the tubular parts being connected. This kind of shaped auxiliary welding material 5* can then be laid over the welding joint before the welding seam 8 is formed by fusing the adjacent components with the aid of the welding device 6.

1. A process for welding a welding seam (8) between two structural components (1, 3; 3, 4), particularly in the production of a filling level gauge, in which
a first structural component (1; 3) and a second structural component (3; 4) are placed together,
an auxiliary welding material (5; 5*) is prepared, and
the first structural component (1; 3) and the second structural component (3; 4) are welded together using the auxiliary welding material upon the introduction of heat, wherein
the auxiliary welding material (5) is placed in the area of the welding seam (8) before the act of welding, and the shape of the auxiliary welding material (5; 5*) is chosen so as to at least partially match the shape of the welding seam (8).

2. A process according to claim 1, in which the first and/or the second structural component (1, 3; 3, 4) exhibits a circular end piece which is to be welded to the other structural component, while the prepared auxiliary welding material is a circularly shaped auxiliary welding material (5; 5*).

3. A process according to claim 1 or 2, in which the auxiliary welding material (5) is positioned between the first and the second structural component (1, 3).

4. A welding device for welding a welding seam (8) between two structural components (1, 3; 3, 4), particularly with a process according to claims 1-3, with a holding device (7) for holding in place the two structural components (1, 3; 3, 4) and the auxiliary welding material (5; 5*),
wherein
the holding device (7) holds the structural components (1, 4) in such a way that a shaped auxiliary welding material (5) remains inserted in the area between the structural components (1, 3) during the welding process.

5. An auxiliary welding material for a process according to one of claims 1-3 or for use in a welding device according to claim 4,
wherein
the auxiliary welding material (5, 5*) is formed with a shape matching the welding seam (8) that is being created and in the vicinity of which the auxiliary welding seam is inserted.

6. An auxiliary welding seam according to claim 5, where the auxiliary welding seam (5, 5*) is given a circular shape.
